(19) United States
(12) Patent Application Publication
(10) Pub. No.: US 2019/0053047 A1
(43) Pub. Date: Feb. 14, 2019

(54) USER TERMINAL AND CONTROL METHOD OF THE SAME

(71) Applicant: Samsung Electronics Co., Ltd., Suwon-si, Gyeonggi-do (KR)

(72) Inventor: Il-Joo KIM, Seoul (KR)

(21) Appl. No.: 16/077,605

(22) PCT Filed: Dec. 14, 2016
(86) PCT No.: PCT/KR2016/014635

§ 371 Date: Aug. 13, 2018

(30) Foreign Application Priority Data
Feb. 17, 2016 (KR) 10-2016-0018614

(51) Int. Cl. H04W 12/02; H04W 4/029

(52) U.S. Cl. CPC H04W 12/02; H04W 4/029

(57) ABSTRACT

Disclosed are a user terminal and a control method of the same, in which security settings are changeable in accordance with external situations. The user terminal includes: a communicator configured to communicate with an external device; a situation sensor configured to sense an external situation; and a controller configured to determine one security setting among a plurality of security settings different in level, based on situation information obtained through at least one of the communicator and the situation sensor, and control the communication with the external device based on the determined security setting.

### TECHNICAL FIELD

The present invention relates to a user terminal, of which security settings are easily changed in accordance with external situations, and a control method of the same.

### BACKGROUND ART

With widespread use of a user terminal such as a smart phone, users have used social network services (SNS) and the like network services a lot. Street View and the like services are likely to violate privacy and collect information without permission, and a function for informing SNS friends of their locations based on global positioning system (GPS) information is also likely to violate privacy. Such a function is capable of tracking location information in real time and automatically notifying of the location information, and therefore details of personal schedules may be fully exposed. Further, the location information may be continuously tracked even while an application is suspended.

In this regard, a security service used to be used, but has not been continuously used in practice. The reason why the security service has not been used is because the security service is perceived as difficult and is also actually complicated and difficult to set. Therefore, the security service is required to be easily set.

### DISCLOSURE

### Technical Problem

Accordingly, an object of the present invention is to provide a user terminal and a control method of the same, in which a level of security settings is changeable while preventing private information from exposure in accordance with external situations (e.g. a place, a time, etc.)

### Technical Solution

The foregoing objects of the present invention are achieved by providing a user terminal comprising: a communicator configured to communicate with an external device; a situation sensor configured to sense an external situation; and a controller configured to determine one security setting among a plurality of security settings different in level, based on situation information obtained through at least one of the communicator and the situation sensor, and control the communication with the external device based on the determined security setting.

Further, the situation information may comprise at least one of information about the external device connecting with the communicator, and information about a location of the user terminal.

Here, the security settings may comprise a permission degree with regard to at least one among location information, phone-call information, contact information, conversation information, message information, and user's private information of the user terminal.

Further, the user terminal may further comprise a storage configured to store information about the user terminal, information about the external device, and information about the security settings, wherein the controller changes the security settings in accordance with the external device when a distance from the external device is within a predetermined range.

Here, the controller may determine connection with the external device and movement, and change the security settings based on determination results.

Further, the controller may set at least one among the situation information, information about the user terminal, and the security settings.

Here, the controller may change the security settings when at least one of an altitude and an acceleration of the user terminal is higher than or equal to a preset value.

Further, the user terminal may further comprise: a storage configured to store an application for setting and modifying the security settings; a display configured to display an image of the application, wherein the controller executes the application stored in the storage in response to a user's input, displays the executed application on the display, and perform at least one of adding, deleting and modifying configuration information with regard to at least one of the situation information, information about the user terminal, and the security settings.

Here, the controller may set the security settings with regard to other applications than the application.

Further, the controller may display an icon for executing the application on a notification window.

The foregoing objects of the present invention are achieved by providing a method of controlling a user terminal, the method comprising: obtaining situation information through at least one of communicating with an external device and sensing external situations; determining one security setting among a plurality of security settings different in level based on the obtained situation information; and controlling the communication with the external device based on the determined security setting.

Further, the situation information may comprise at least one of information about the external device connecting with the communicator, and information about a location of the user terminal.

Here, the security settings may comprise a permission degree with regard to at least one among location information, phone-call information, contact information, conversation information, message information, and user's private information of the user terminal.

Further, the determining of the security settings may comprise changing the security settings in accordance with the external device when a distance from the external device is within a predetermined range.

Here, the determining of the security settings may comprise: determining connection with the external device and movement; and changing the security settings based on determination results.

Further, the method may further comprise setting at least one among the situation information, information about the user terminal, and the security settings.

Here, the determining of the security settings may comprise changing the security settings when at least one of an altitude and an acceleration of the user terminal is higher than or equal to a preset value.

Further, the method may further include executing a stored application, capable of setting and modifying the security settings, in response to a user's input; displaying the executed application; and performing at least one of adding, deleting and modifying configuration information with regard to at least one of the situation information, information about the user terminal, and the security settings.

Here, the performing of the at least one may comprise setting the security settings with regard to other applications than the application.

Further, the method may further comprise displaying an icon for executing the application on a notification window.

### Advantageous Effects

According to the present invention, a level of security settings is easily changed in accordance with external situations (a place, time, etc.), thereby having an effect on preventing user's private information from exposure anywhere and at any time.

### DESCRIPTION OF DRAWINGS

FIG. 1 is a diagram of showing an example that a user terminal according to one embodiment of the present invention is used to set security settings in various cases,

FIG. 2 is a block diagram of showing a configuration of a user terminal according to the present invention,

FIG. 3 is a block diagram of showing a configuration of a user terminal according to one embodiment of the present invention,

FIG. 4 is a control flowchart of showing operations of a user terminal according the present invention,

FIG. 5 is a control flowchart of showing operations of a user terminal according to one embodiment of the present invention,

FIG. 6 is a control flowchart of showing operations of a user terminal according to another embodiment of the present invention,

FIG. 7 is a diagram of showing an example that a user terminal according to one embodiment of the present invention is used to set/change security settings,

FIG. 8 is a block diagram of showing an internal configuration of a user terminal according to one embodiment of the present invention,

FIGS. 9A, 9B, 9C, 10A, 10B, 10C and 11 are diagrams of showing detailed examples of setting/changing security settings of a user terminal according to one embodiment of the present invention,

FIG. 12 is a diagram of showing an example of a configuration for permission degrees in a user terminal according to one embodiment of the present invention,

FIGS. 13 to 17 are diagrams of showing examples of various security settings of a user terminal according to one embodiment of the present invention,

FIGS. 18, 19A, 19B and 19C are diagrams of showing examples of information about security settings of a user terminal according to one embodiment of the present invention.

### BEST MODE

Hereinafter, the present invention will be described in detail with reference to accompanying drawings. The present invention may be embodied in various different forms, and not limited to the embodiments set forth herein. For convenience of description, parts unrelated to the descriptions are omitted, and the same numerals refer to the same or like elements throughout.

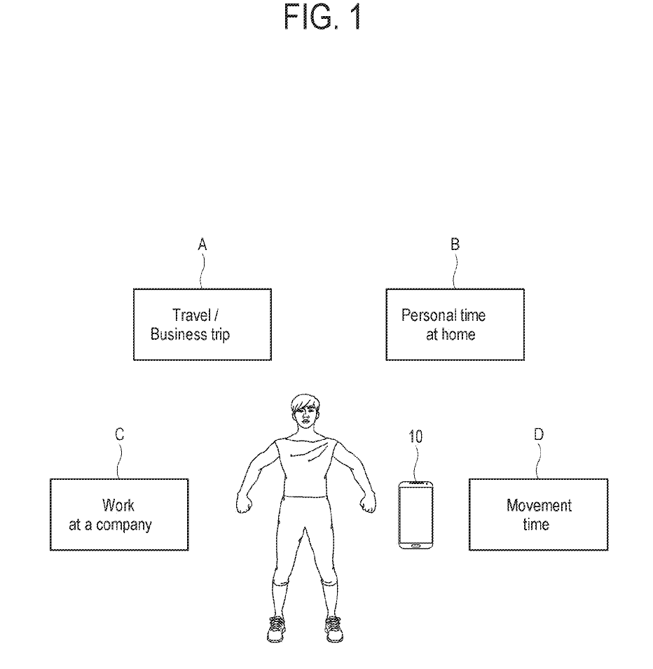

FIG. 1 is a diagram of showing an example that a user terminal 10 according to one embodiment of the present invention is used to make security settings in various cases,

The security settings of the user terminal 10 may be varied depending on various situations.

‘A’ shows a situation that a user takes a trip, in which the security settings for a location may be not strongly set according to users. When the level of the security settings ranges from ‘1’ to ‘10’, the situation of ‘A’ may be set to have a security level of ‘2’ to ‘3’.

‘B’ shows a situation that a user gets off work and spends time alone, in which the security settings may be set not to expose a location and the like private information to anybody. A user may select the strongest security level.

‘C’ shows a situation that a user goes to work and works at a company, in which a higher security level has to be set with regard to business. In this case, the security stings may be made to distinguish between private data and business data.

‘D’ shows a situation that a user moves for going to work, getting off work and the like, in which the user terminal 10 may have security vulnerabilities. Taking the security vulnerabilities into account, the security settings may be made. In a case of using a bus or a subway as the means of transportation, a Wi-Fi router may be provided. The user terminal 10 may automatically have an access to the router. In the case of having such an automatic access, information of the user terminal 10 may be exposed to other undesired user terminals or an external server.

The user terminal 10 may have different security settings according to various external situations as described above, and prevent the private information from exposure, thereby easily making the security settings be adaptively set according to the situations.

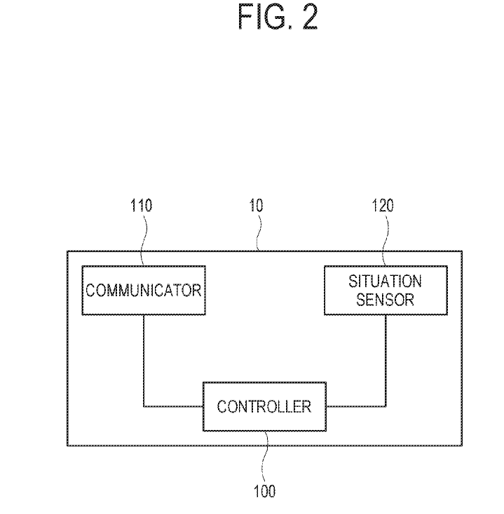

FIG. 2 is a block diagram of showing a configuration of a user terminal 10 according to the present invention. The user terminal 10 according to the present invention includes a communicator 110, a situation sensor 120, and a controller 100.

The communicator 110 may receive a signal based in an external input and transmit the signal to a signal processor 130 or the controller 100. The communicator 110 may connect with various external input cables to receive a signal from a corresponding external input through a wire, or receive a signal wirelessly according to preset wireless communication standards.

The communicator 110 may include a plurality of connectors (not shown) to which each cable is individually connected. The communicator 110 may receive a signal from the connected external input, and may for example receive a broadcast signal, an image signal, a data signal, etc. according to high definition multimedia interface (HDMI), a universal serial bus (USB) and Component standards, or communication data through a communication network.

The communicator 110 may include an element configured to receive a signal/data from an external input, and may further include various elements such as a wireless communication module (not shown) for wireless communication, and a tuner (not shown) for receiving a broadcast signal in accordance with designs of the user terminal 10. The communicator 110 may not only receive a signal from an external device, but also transmit information/data/signal of the user terminal 10 to the external device. That is, the communicator 110 is not limited to receiving a signal from an external device, but may be achieved by an interface for interactive communication. The communicator 110 may receive a control signal for selecting a user interface (UI) from a plurality of control devices. The communicator 110 may include communication modules for publicly known near field communications such as Bluetooth, infrared (IR), Ultra-Wideband (UWB), ZigBee, etc. and may include a well-known communication port for wired communication. The communicator 110 may be utilized for various purposes such as transmitting and receiving a command for controlling a display, data, etc. as well as a control signal for selecting a UI.

The situation sensor 120 may be materialized by various sensors. The situation sensor 120 may include an accelerometer sensor, a global positioning system (GPS), a barometric sensor, a gyroscope sensor, a proximity sensor, a geo-magnetic sensor, etc., thereby sensing a situation in which the user terminal 10 is.

The controller 100 may be configured to control general elements of the user terminal 10. The controller 100 determines one among a plurality of security settings different in level, based on situation information obtained through at least one of the communicator 110 and the situation sensor 120, and controls communication with an external device in accordance with the determined security settings.

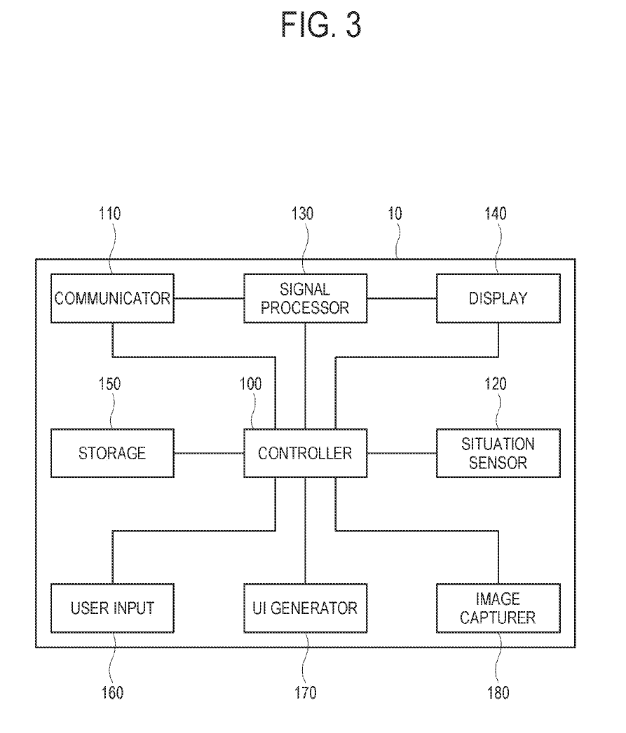

FIG. 3 is a block diagram of showing a configuration of a user terminal 10 according to one embodiment of the present invention. According to one embodiment of the present invention, the user terminal 10 may include elements shown in FIG. 2, and may further include a signal processor 130, a display 140, a storage 150, a user input 160, a UI generator 170, and an image capturer 180.

The signal processor 130 performs image processing processes without limitations, such as de-multiplexing for dividing a predetermined signal into signals corresponding to characteristics, decoding corresponding to an image format of an image signal, de-interlacing for converting an interlaced-type image signal into a progressive-type image signal, noise reduction for improving image quality, detail enhancement, frame refresh rate conversion, etc. The signal processor 130 may include a decoder (not shown) for decoding a source image in accordance with an image format of an encoded source image, and a frame buffer (not shown) for storing the decoded source image in units of frame.

The signal processor 130 may be materialized by a system-on-chip in which various functions are integrated, or an image processing board (not shown) that individual elements for independently implementing such processes are mounted on a printed circuit board, and may be internally provided in a signal receiver.

The signal processor 130 applies various preset image processing processes to a source image including a broadcast signal including an image signal received from the communicator 110, and an image signal received from the image source (not shown). The signal processor 130 outputs the image signal subjected to such processes to the user terminal 10, so that the processed source image can be displayed on the user terminal 10.

The display 140 may display an image based on the image signal output from the signal processor 130. There are no limits to the types of the display 140. For example, the display 140 may be materialized by various display types such as liquid crystal, plasma, a light-emitting diode, an organic light-emitting diode (OLED), a surface-conduction electron-emitter, a carbon nano-tube, nano-crystal, etc.

The display 140 may include additional elements in accordance with its type. For example, in the case of the liquid crystal type, the display 140 may include a liquid crystal display (LCD) panel (not shown), a backlight unit (not shown) for emitting light to the LCD panel, and a panel driving board (not shown) for driving the LCD panel (not shown).

The display 140 displays an image based on an image signal processed by the signal processor 130. There are no limits to a method of displaying an image on the display 140. For example, the method may include a LCD, plasma display panel (PDP), an OLED, etc. In this case, the display 140 may include an LCD panel, a PDP, an OLED panel, or the like.

The display 140 may display an image and color calibration procedure. The display 140 may include the display panel for displaying an image, and a panel driver for processing an input image signal to be displayed as an image on the display panel, but there are no limits to detailed materializations. An image signal received from an external input source through an interface is subjected to the image processing processes such as decoding, de-interlacing, scaling, etc. and then displayed on the display 140. When the controller 100 (to be described later) performs the color calibration in response to a user's command, the display 140 may display the color calibration procedure including a color patch, a color calibration state window, etc.

The storage 150 may be provided a nonvolatile memory (or writable read only memory (ROM) so as to retain data even though the user terminal 10 is turned off and reflect changes made by a user. That is, the storage 150 may be materialized by one of a flash memory, an erasable and programmable read only memory (EPROM), and an electrically erasable and programmable read only memory (EEPROM). The storage 150 may be configured to store information about the user terminal 10, information about an external device, and information about the security settings. The storage 150 may be configured to store an application for setting and changing the security settings.

The user input 160 may transmits various preset control commands or information to the controller in response to a user's control and input. The user input 160 may be materialized by a menu key or input panel installed at an outer side of the user terminal 10, a remote controller separated from the user terminal 10, etc. Alternatively, the user input 160 and the display 140 may be materialized as a single body. When the display 140 is provided as a touch-screen, a user may touch an input menu (not shown) displayed on the display, thereby transmitting a preset command to the controller 100.

The user input 160 may receive a user's motion and voice. A user's motion may include a touch input. The user input 160 may directly receive a user's motion and voice. Alternatively, information about a user's motion and voice may be received from an external device.

The UI generator 170 may generate a UI for operating an application program to be executed. The generated UI includes a plurality of sub UIs given in the form of an icon, a text, or the like. When a user selects a certain sub UI through the user terminal 10, an application program may operate with regard to the selected sub UI. That is, each sub UI may be generated in units of a plurality of functions or events for operating an application program running in the display apparatus.

The UI generator 170 refers to a software or hardware function for generating and controlling the UI displayed on the display 140, and the function may be implemented by the controller 100 to be described later. In other words, the UI generator 170 may be configured by a separate chipset, or may not be materialized by a separate microprocessor.

The image capturer 180 may be materialized by a camera.

The controller 100 may include a control program for implementing the foregoing control operations, a nonvolatile memory in which the control program is installed, a volatile memory to which at least a part of the installed control program is loaded, and at least one microprocessor for executing the loaded control program. The control program may include a program(s) given in the form of at least one among a basic input/output system (BIOS), a device driver, an operating system, a firmware, a platform, and the like application program. According to one embodiment, the application program may be previously installed or stored in the user terminal 10 when the user terminal 10 is manufactured, or the application program is received as data from an external device and installed in the user terminal 10 when used in the future. The external device refers to a recording medium configured to store data of a program to be executed by the computer, and may be a recording medium configured to store data about the application program. Alternatively, the external device may be a network server, and the data of the application program may be for example downloaded from an application program market and the like network server to the user terminal 10. In this case, the network server may provide the data of the application program stored in the recording medium to the user terminal 10.

The controller 100 may change the security settings in accordance with the external device when a distance from the external range is within a predetermined range. The situation information may include at least one of information about the external device connecting with the communicator, and information about location of the user terminal. The security settings may include permission degrees about at least one among location information, phone-call information, contact information, conversation information, message information, a user's private information, etc. of the user terminal.

The controller 100 determines connection with the external device or movement, and changes the security settings based on determination results. The determination of the connection with the external device is to determine whether a router is for public use without a password or for home use with a password. Further, the determination of the movement is to determine whether a router is installed in such a means for transportation as a bus or a subway. When it is determined that the router is provided in a moving bus, the security settings of the user terminal 10 may be changed into security settings for movement.

The controller 100 may set at least one among situation information, information about the user terminal 10, and the security settings. For instance, when the user terminal senses various devices in a user's home, the security settings may be changed into security settings for home. Like this, a user may register various devices of home and previously set the security settings to be changed for home the when the registered devices are detected. Further, it is set to implement not the security settings for home but other security settings when the distance from many devices of home the user terminal 10 gets out of a predetermined range.

The controller 100 may change the security settings when at least one of the altitude and acceleration of the user terminal 10 is higher than or equal to a preset value. To go to work, a user may walk or use a vehicle, public transportation, a bicycle, a motorbike, etc. Such a means for transportation has a moving speed within some ranges of acceleration, and is thus set in this regard. However, when an airplane is used among many means of transportation, the user terminal 10 may go beyond usual bounds of an altitude and acceleration. This case may be different from a user's daily life and often include a private trip or a business trip, and therefore security settings for this case are required. Accordingly, the user terminal may change the security settings.

The controller 100 executes an application stored in the storage 150 in response to a user's input, and displays the application on the display 140, thereby performing at least one of addition, deletion, and modification for configuration information with regard to at least one among the situation information, the information about the user terminal, and the security settings. When a user's life pattern is changed, the security settings may be modified in this regard. In response to such a change in the life pattern, the configuration information may be added, deleted or modified.

The controller 100 may set the security settings with regard to other applications than the application. Regarding each application, the security settings may be provided. For instance, when the security settings are made with regard to each application, the security settings may be made one by one after displaying the plurality of applications, or the security settings may be made by selecting the plurality of applications with respect to a security level. Further, the security settings may be made by setting the security level for each individual application with respect to the plurality of situations, or by setting the security levels with regard to the plurality of situations and selecting the plurality of applications with respect to the security level.

The controller 100 may display an icon for executing the application on a notification window. The notification window may be displayed when a screen top on the display 140 of the user terminal 10 is touched and dragged down. This notification window serves to notify of content received through various communications. The notification window may show an application running for the security. The security settings may be not selected for the application displayed on the notification window. In this case, a message may be displayed to inform that the security settings are selectable, and a button for implementing the security settings may be provided so that a configuration screen for setting the security can be displayed when a user presses the button. When the security settings are selected for the application displayed on the notification window, a title of the selected security settings may be displayed. Further, information about the security settings may be displayed. The information about the security settings may include state information about the security settings, level information, security type, the number of use times according to the security types, an icon for checking statistical information about the security, etc. When the icon for checking the statistical information about the security is touched, it is possible to check various pieces of statistical information about the security settings for the security types, applications, situations, etc. Thus, a user may modify or newly set the security settings while the security settings are implemented. Further, the state information about the security settings, the level information, the security type, the number of use times according to the security types, the icon for checking the statistical information about the security, etc. may be set to be different in color and distinguished among them, and may notify of the permission degree of the security.

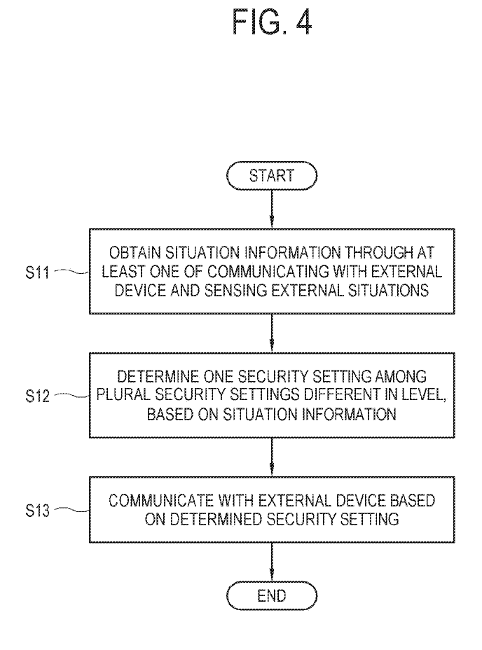

FIG. 4 is a control flowchart of showing operations of the user terminal 10 according the present invention.

Situation information is obtained through at least one of communication with an external device and external situations (S11).

One security setting is determined among a plurality of security settings based on the obtained situation information (S12).

Communication with the external device is performed in accordance with the determined security settings (S13).

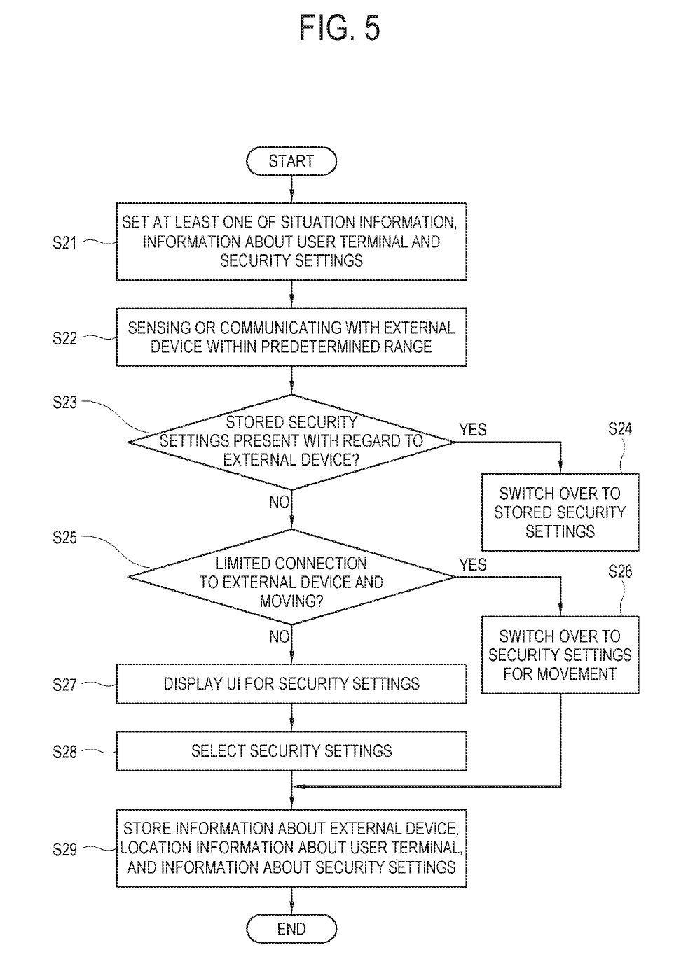

FIG. 5 is a control flowchart of showing operations of the user terminal 10 according to one embodiment of the present invention.

At least one among situation information, information about the user terminal, and security settings is set (S21). For instance, an external device is registered, and security settings are made corresponding to the registered external device. The information about the user terminal may be data including at least one among location information, phone-call information, contact information, conversation information, message information and a user's private information of the user terminal.

An external device located within a predetermined range is detected or connected for communication (S22).

It is determined whether there are security settings stored with regard to the external device (S23).

The user terminal 10 registers the external device and changes the security settings into the stored security settings when there the security settings are stored corresponding to the registered external device (S24).

When there are no security settings stored with regard to the external device, it is determined whether connection to the external device is limited or whether the external device moves (S25).

When a password is not set for the external device and the external device is moving, the security settings may be changed into security settings previously set for the movement (S26).

When a password is set for the external device and the external device is stationary, a UI for the security settings is displayed (S27).

A user selects the security settings through the displayed UI for the security settings (S28).

The security settings for the movement, the information about the external device, the information about the location of the user terminal, and the information about the security settings are stored (S29).

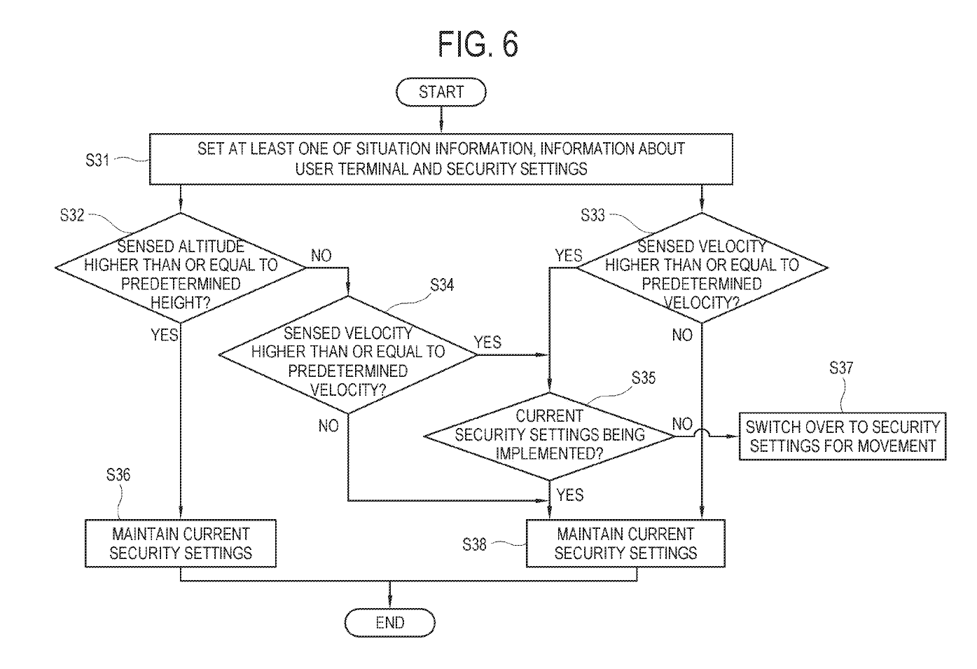

FIG. 6 is a control flowchart of showing operations of the user terminal 10 according to another embodiment of the present invention.

At least one among situation information, information about a user terminal, and security settings are set (S31). For instance, an external device is registered, and security settings are made corresponding to the registered external device. The information about the user terminal may be data including at least one among location information, phone-call information, contact information, conversation information, message information and a user's private information of the user terminal.

The controller 100 determines whether an altitude sensed by the situation sensor 120 is higher than or equal to a predetermined height (S32).

When it is determined that the sensed altitude is higher than or equal to the predetermined height, the security settings are changed into trip security settings (S36). In this case, the security settings are changed determining that a user goes on a private trip or a business trip by airplane. A user may previously set the security settings for a travel. When a user does not previously set the security settings, security settings screen may be displayed to set the security.

When it is determined that the sensed altitude is lower than the predetermined height, the controller 100 determines whether a moving velocity (acceleration) sensed by the situation sensor 120 is higher than or equal to a predetermined speed (acceleration) (S34).

When it is determined that the sensed moving velocity (acceleration) is higher than or equal to the predetermined velocity (acceleration), it is determined whether the current security settings are selected and implemented (S35).

When it is determined that there are no security settings being implemented, change into a moving security settings is made (S37).

When it is determined that the moving velocity (acceleration) sensed in the operation S34 is lower than the predetermined velocity (acceleration) or when there are security settings being implemented, the security settings being currently implemented is maintained (S38).

After the operation S31, the controller 100 determines whether the moving velocity (acceleration) sensed by the situation sensor 120 is higher than or equal to a predetermined velocity (acceleration) (S33).

When the sensed moving velocity (acceleration) is higher than or equal to the predetermined velocity (acceleration), the operation S35 is performed. On the other hand, when the sensed moving velocity (acceleration) is lower than the predetermined velocity (acceleration), the current security settings are maintained.

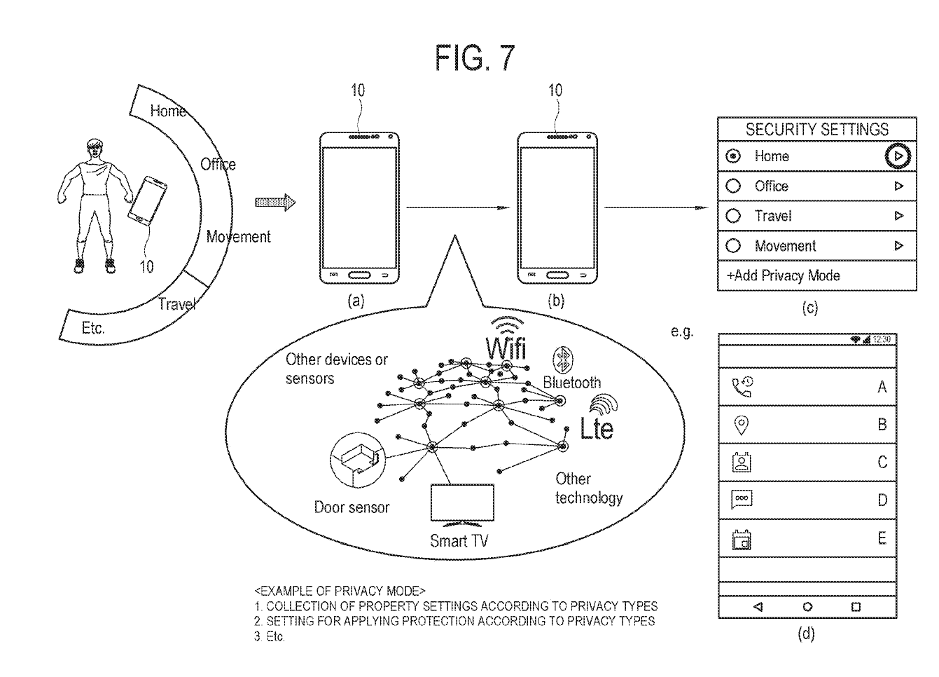

FIG. 7 is a diagram of showing an example that the user terminal 10 according to one embodiment of the present invention is used to set/change security settings,

(a) The user terminal 10 detects a Wi-Fi router within a network of a home while a user is carrying the user terminal 10 and moving closer to the home

(b) The user terminal 10 is connected to the external device, i.e. the Wi-Fi router. The detected external device may be a TV, an Internet terminal or a Bluetooth device in the home.

(c) It is determined whether security settings are previously stored with regard to the external device, i.e. the Wi-Fi router. When the stored security settings are present, change into the stored security settings is made. When the stored security settings are not present, a UI screen for the security settings may be displayed. In this case, the title of the security settings may set, but content thereof may be not set.

(d) Thus, a user selects ‘Home’ and sets the security level for the Wi-Fi router. Further, the security settings may be set for an application. The security level may be made to set a permission degree. The set permission degree is applied even to an SNS application of a user, and therefore a degree of opening data to be uploaded/downloaded to the public may be set differently according to users.

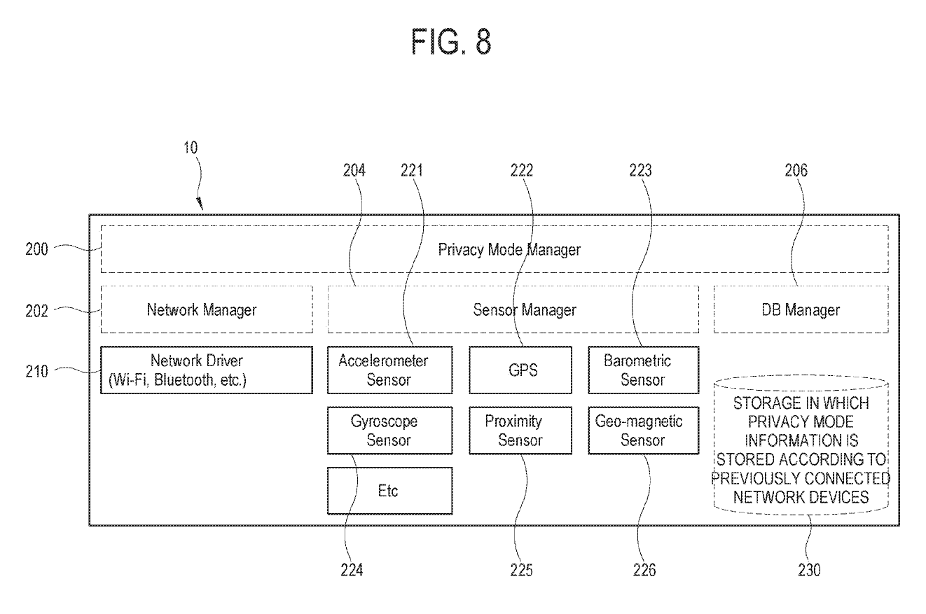

FIG. 8 is a block diagram of showing an internal configuration of the user terminal 10 according to one embodiment of the present invention. According to one embodiment of the present invention, the user terminal 10 may include a privacy mode manager 200, a network manager 202, a sensor manager 204, a database (DB) manager(206), a network driver (Wi-Fi, Bluetooth, etc.) 210, an accelerometer sensor 221, a GPS 222, a barometric sensor 223, a gyroscope sensor 224, a proximity sensor 225, a geo-magnetic sensor 226, and a storage 230 in which privacy mode information is stored according to previously connected network devices.

The privacy mode manager 200, the network manager 202, the sensor manager 204, and the DB manager 206 may be materialized by some modules of the controller 100. The privacy mode manager 200 may serve to manage/control information from the network manager 202, the sensor manager 204, and the DB manager 206.

The network Manager 202 may manage information received from the network driver (Wi-Fi, Bluetooth, etc.) 210 corresponding to the communicator 110, and transmit the information to the privacy mode manager 200.

The sensor manager 204 may manage information received from the accelerometer sensor 221, the GPS 222, the barometric sensor 223, the gyroscope sensor 224, the proximity sensor 225 and the geo-magnetic sensor 226 corresponding to the situation sensor 120, and transmit the information to the privacy mode manager 200. However, there are no limits to such sensors, and various sensors are possible as long as they can sense situations.

The DB manager 206 may manage and store data from the storage 230, in which privacy mode information is stored according to previously connected network devices, corresponding to the storage 150, and transmit information to the privacy mode manager 200,

The privacy mode manager 200 may determine one security settings among a plurality of security settings different in level, based on the situation information obtained through at least one of the network manager 202 and the sensor manager 204.

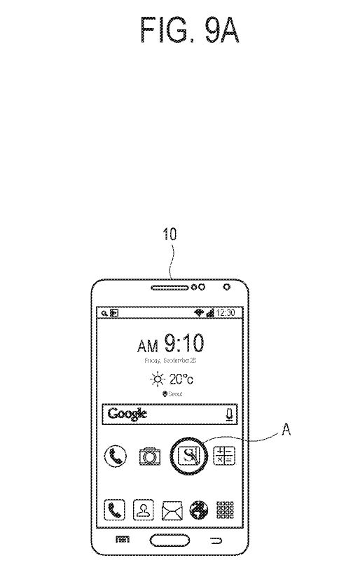

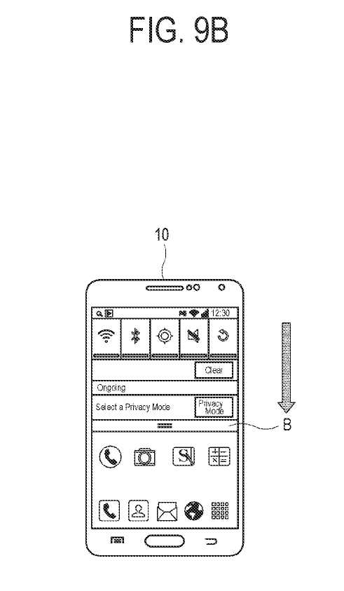

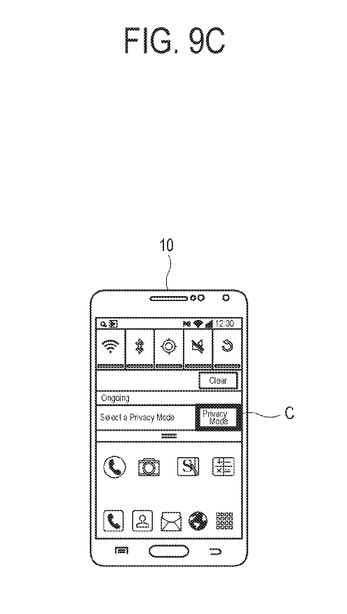

FIGS. 9A, 9B, 9C, 10A, 10B, 10C and 11 are diagrams of showing detailed examples of setting/changing security settings of a user terminal 10 according to one embodiment of the present invention.

Referring to FIG. 9A, an icon A of an application for the security settings may be displayed to be selectable on a screen of the display 140 in the user terminal 10. When the displayed icon is selected, the application may be executed for the security settings to be set/modified.

Referring to FIG. 9B, a screen top B is of the display 140 in the user terminal 10 is touched and dragged downward to display a notification window, and the notification window shows buttons for executing the applications for the security settings.

Referring to FIG. 9C, the button for executing the applications for the security settings, shown in FIG. 9B, is selected/touched to execute the application for the security settings.

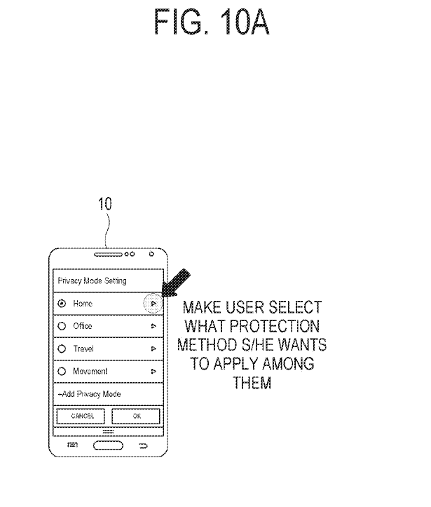

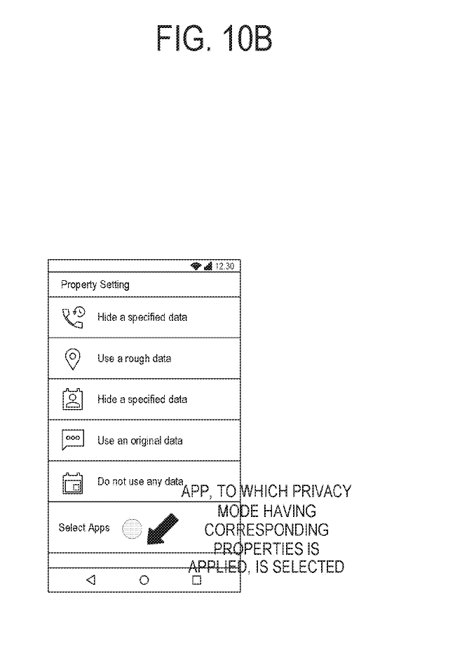

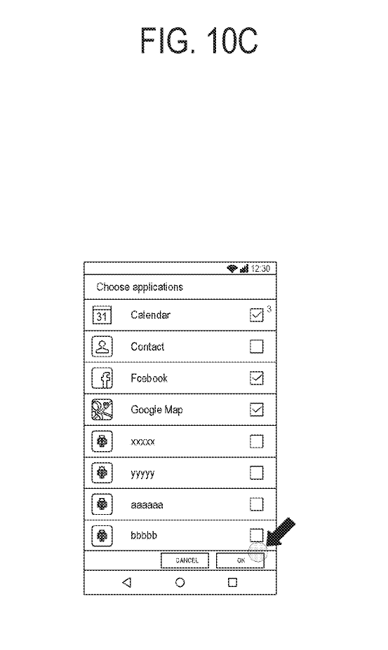

Referring to FIG. 10A, the application for the security settings is executed displaying the titles of the security settings. A user may select ‘Home’ so as to select which protection method s/he wants to apply among them.

Referring to FIG. 10B, a level for selecting the permission degree of the security may be displayed as ‘Home’ is selected. After selecting the level, the bottom Select Apps may be touched/selected to show the application to which this selected level will be applied.

Referring to FIG. 10C, the plurality of applications is displayed, and a check box for selection is displayed at a right side so that the same security level can be applied to the plurality of applications. In this embodiment, a calendar, an SNS application, and a map application are selected, and the bottom OK button may be selected/touched when the selection is completed.

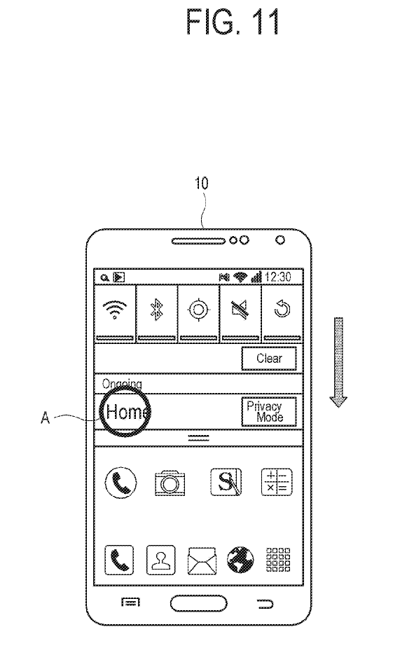

FIG. 11 shows that the security settings are completed and implemented, when the notification window of the user terminal 10 is opened after finishing the settings in FIGS. 9A, 9B, 9C, 10A, 10B and 10C. FIG. 11 shows that the current security settings are set to ‘Home’ A. Here, when a right button for the security settings is pressed, the setting screen shown in FIG. 10A is displayed to set the security settings again.

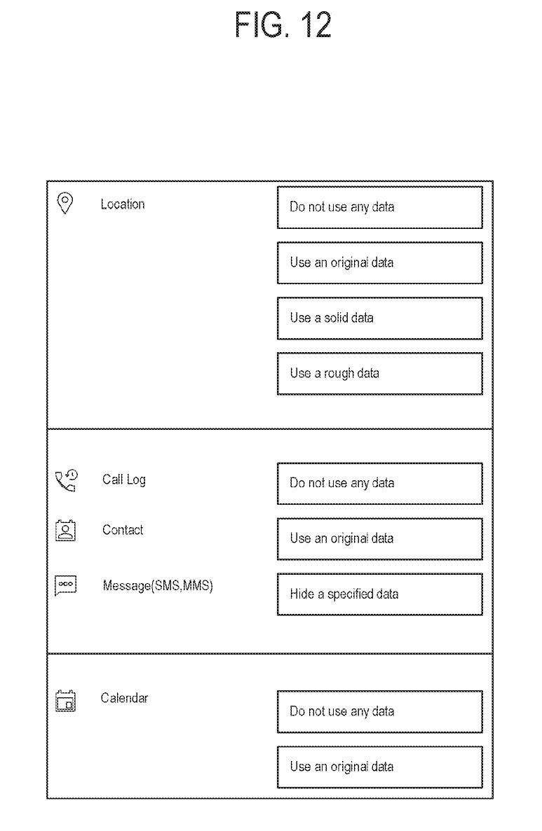

FIG. 12 is a diagram of showing an example of a configuration for permission degrees in a user terminal according to one embodiment of the present invention.

The information desired to be protected in the security settings is information related to ‘Location’, ‘Contact’, ‘Call Log’, ‘Calendar’, and ‘Message’. To set a degree of open such information to the public, a plurality of permission degrees are provided. In accordance with related information, content about the permission information may be differently set, and the kind and the number thereof may be also changed. The security may be set to open previous data to the public even though the current data is being changed, thereby preventing real-time data of the current user from being opened to the public. Such a security setting method is not limited to a certain method, and contents about permission degrees and security settings may be varied depending on a user's intention.

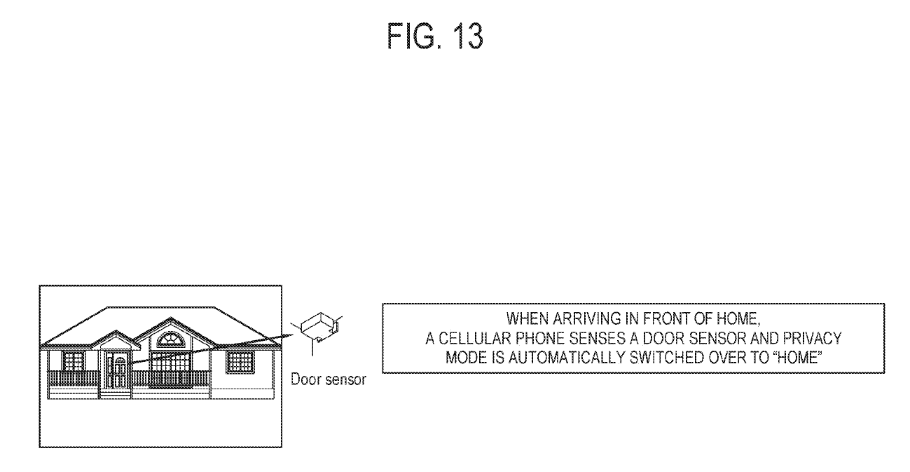

FIGS. 13 to 17 are diagrams of showing examples of various security settings of the user terminal 10 according to one embodiment of the present invention.

Referring to FIG. 13, when a user arrives in front of home, the user terminal 10 senses a door sensor and automatically switches over to security settings for the home among the stored security settings. For instance, the security settings for a location are set to have a low level while moving, but set to have the highest level as the security settings are changed into those for the home.

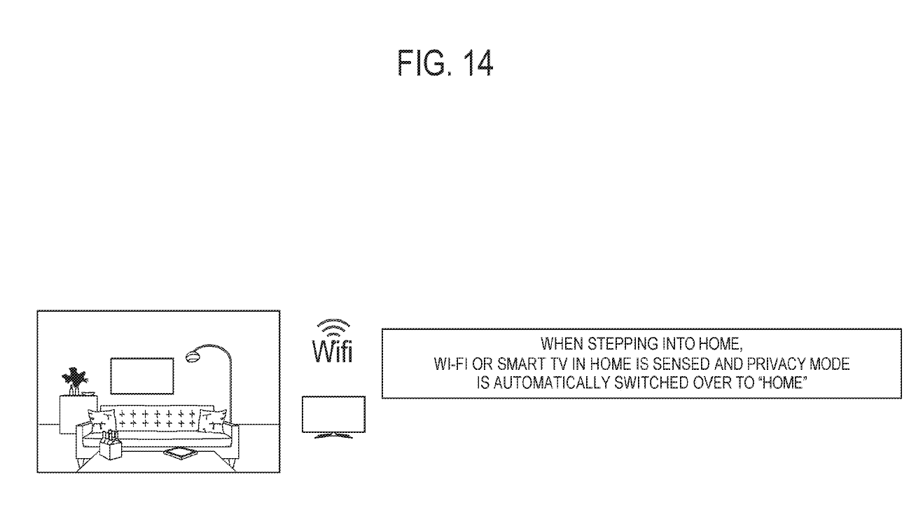

Referring to FIG. 14, when a user steps into the home, the user terminal 10 senses a Wi-Fi router or a TV and automatically switches over to security settings for the home among the stored security settings.

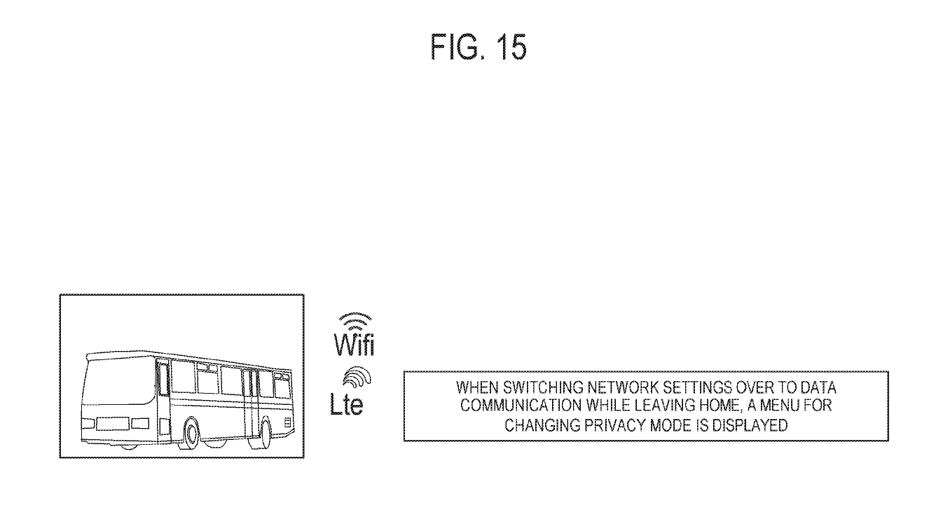

FIG. 15 shows that a user leaves home in the morning and takes a subway to go to work. The user terminal 10 senses and accesses a Wi-Fi router offered in the subway, and switches over to security settings for movement. Further, it is also possible to switch over to the security settings for the movement when a user uses a data network for communication without using the Wi-Fi network while going to work.

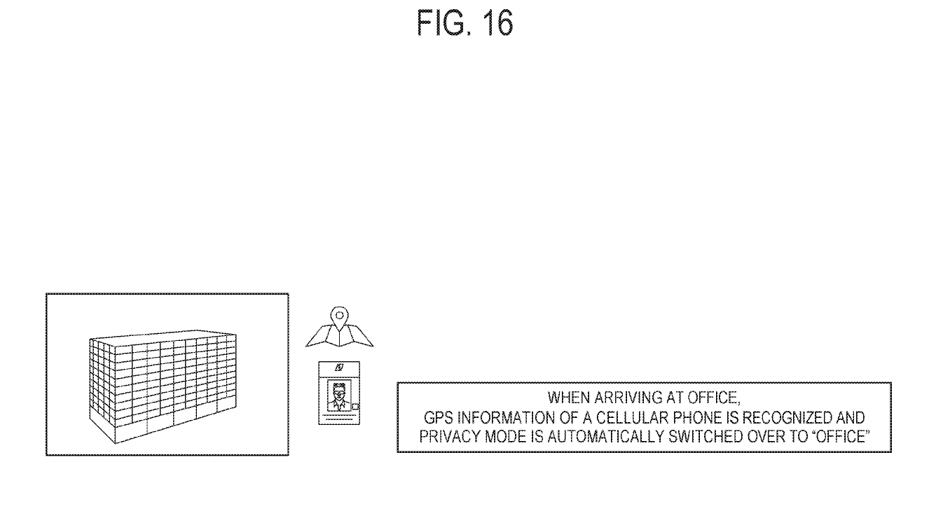

Referring to FIG. 16, when a user arrives at office and touches an employee card to a card reader, the user terminal 10 senses an entrance door and switches over to the security settings for an office. Further, a user's life pattern is taken into account, and it is determined whether location information matches with company location, thereby switching the security settings. Since the user terminal 10 is capable of sensing other neighboring user terminals, the user terminal 10 may switch over to the security settings for the office based on sensing results (the sense, the sensed number, etc.) of other user terminals.

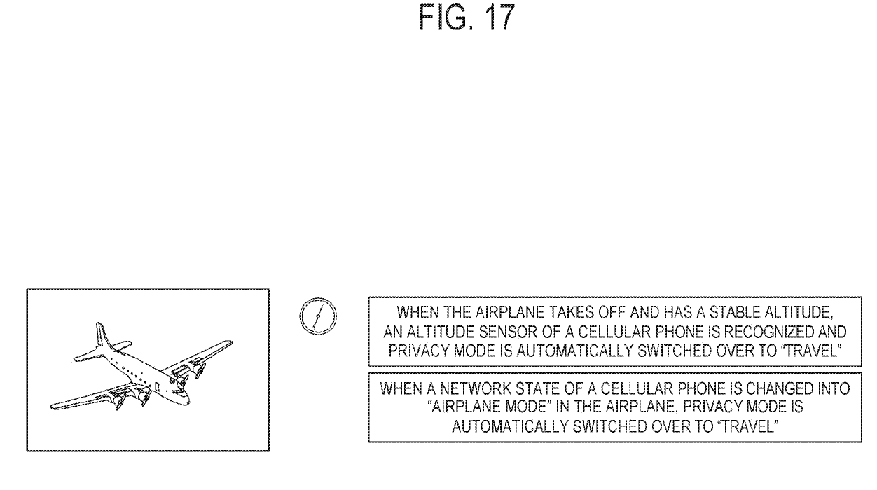

FIG. 17 shows that a user goes on a private trip or a business trip by airplane, in which an altitude sensor of the user terminal 10 senses whether the airplane takes off and has a stable altitude, and the controller 100 switches over to the security settings for a travel when the altitude of the airplane is stabilized. Alternatively, the controller 100 may switch over to the security settings for the travel when the network state is changed into an airplane mode in accordance with guidance when the airplane takes off.

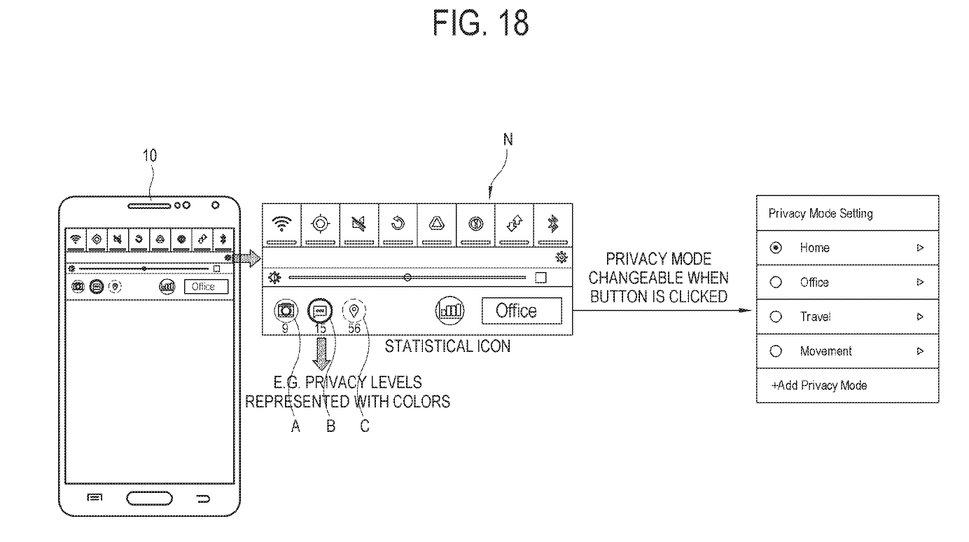

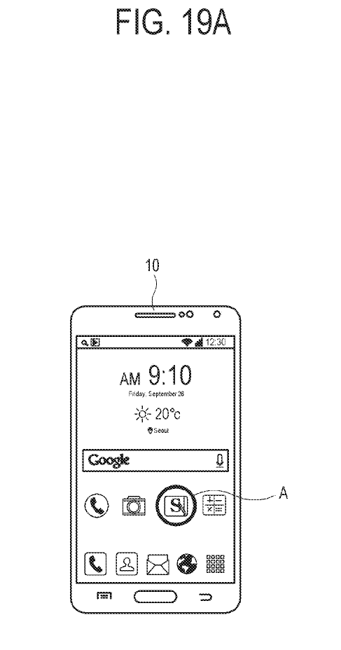

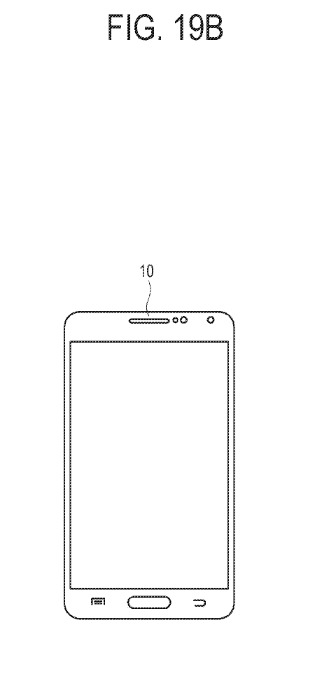

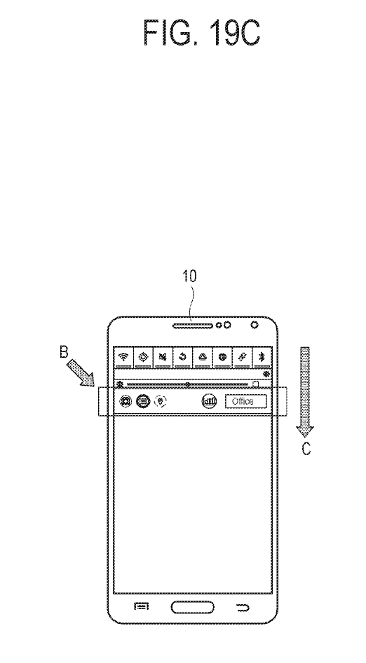

FIGS. 18, 19A, 19B and 19C are diagrams of showing examples of information about security settings of the user terminal 10 according to one embodiment of the present invention.

When the top screen of the user terminal 10 is touched and dragged, a notification window N may be displayed. The notification window N may show pieces of information about the kinds of security with different colors so that the information about the security settings can be intuitively checked. Further, it may be represented by numerals how many times the security data set with different colors is used. Besides, a security statistical icon is provided, so that statistical information about security can be recognized at a glance by displaying statistical data according to time periods, the kinds of security, etc.

FIG. 18 shows situations of using the data about the security with a camera application A of ‘9’, a message application B of ‘15’, and a location application C of ‘56’. The notification window N shows that the security settings for the office are being implemented. Here, when a button for the security settings for the office is pressed, a screen may be changed and displayed for making security settings.

Referring to FIGS. 19A, 19B and 19C, FIG. 19A shows that one of applications being displayed on the user terminal 10 is selected.

FIG. 19B shows that the selected application is executed.

FIG. 19C shows information about permission degrees for security the application being currently executed has.

With the foregoing user terminal 10, the security settings may be implemented to protect private information, and the security settings considered as difficult are conveniently and easily made. The security settings may be modified corresponding to the external situations by taking a user's life pattern into account, thereby properly protecting the private information.

Although embodiments of the present invention are described in detail, various changes can be made without departing from the principle or scope of the present invention by a person having an ordinary skill in the art to which the present invention pertains. Thus, the scope of the present invention is not limited to the embodiments described above, but defined by the appended claims and equivalents thereof.

1. A user terminal comprising:
a communicator configured to communicate with an external device;
a situation sensor configured to sense an external situation; and
a controller configured to:
determine one security setting among a plurality of security settings different in level, based on situation information obtained through at least one of the communicator and the situation sensor, and
control the communication with the external device based on the determined security setting.

2. The user terminal according to claim 1, wherein the situation information comprises at least one of information about the external device connecting with the communicator, and information about a location of the user terminal.

3. The user terminal according to claim 1, wherein the security settings comprise a permission degree with regard to at least one among location information, phone-call information, contact information, conversation information, message information, and user's private information of the user terminal.

4. The user terminal according to claim 1, further comprising a storage configured to store information about the user terminal, information about the external device, and information about the security settings,
wherein the controller changes the security settings in accordance with the external device when a distance from the external device is within a predetermined range.

5. The user terminal according to claim 1, wherein the controller determines connection with the external device and movement, and changes the security settings based on determination results.

6. The user terminal according to claim 1, wherein the controller sets at least one among the situation information, information about the user terminal, and the security settings.

7. The user terminal according to claim 1, wherein the controller changes the security settings when at least one of an altitude and an acceleration of the user terminal is higher than or equal to a preset value.

8. The user terminal according to claim 1, further comprising:
a storage configured to store an application for setting and modifying the security settings; and
a display configured to display an image of the application, wherein the controller is further configured to:
execute the application stored in the storage in response to a user's input,
display the executed application on the display, and
perform at least one of adding, deleting and modifying configuration information with regard to at least one of the situation information, information about the user terminal, and the security settings.

9. The user terminal according to claim 8, wherein the controller sets the security settings with regard to other applications than the application.

10. The user terminal according to claim 8, wherein the controller displays an icon for executing the application on a notification window.

11. A method of controlling a user terminal, the method comprising:
obtaining situation information through at least one of communicating with an external device and sensing external situations;
determining one security setting among a plurality of security settings different in level based on the obtained situation information; and
controlling the communication with the external device based on the determined security setting.

12. The method according to claim 11, wherein the situation information comprises at least one of information about the external device connecting with the communicator, and information about a location of the user terminal.

13. The method according to claim 11, wherein the security settings comprise a permission degree with regard to at least one among location information, phone-call information, contact information, conversation information, message information, and user's private information of the user terminal.

14. The method according to claim 11, wherein the determining of the security settings comprises changing the security settings in accordance with the external device when a distance from the external device is within a predetermined range.

15. The method according to claim 11, wherein the determining of the security settings comprises:
determining connection with the external device and movement; and
changing the security settings based on determination results.
